(19) United States
(12) Patent Application Publication
(10) Pub. No.: US 2007/0196623 A1
(43) Pub. Date: Aug. 23, 2007

(54) Laser or ink jet printable sheet assembly

(75) Inventors: Wayne Bilodeau, Gorham, ME (US); Jeremy Krupat, Atlanta, GA (US); Steve Weirather, Lawrenceville, GA (US); Jerry Funderburk, Demorest, GA (US)

Correspondence Address: AVERY DENNISON CORPORATION;Patent Group, Law Department - 3 South, P.O. BOX 7090, PASADENA, CA, 91109-7090, US

(73) Assignee: Avery Dennison Corporation

(21) Appl. No.: 11/359,188

(22) Filed: Feb. 21, 2006

(51) Int. Cl. B32B 3/10

(52) U.S. Cl. 428/136; 428/40.1

(57) ABSTRACT

A sheet assembly including a sheet of paper or polymer film having a first surface and a second opposed surface, and having a coating material formed on at least the second surface of the sheet. A plurality of parallel substantial-cut lines extend substantially the length and width of a sheet to define two columns of card blanks on the sheet. The substantial-cut lines do not extend substantially into the coating material formed on the second surface of the card assembly. The sheet is passed through a laser or ink jet printer, printing the desired identifying or other indicia on the blanks. The blanks are then separated along the substantial-cut line(s). The cards separate cleanly along the substantial-cut lines, superior to microperforated card separation lines. Even with the substantial-cut line(s), the sheets maintain sufficient integrity to reliably pass through the printer without breaking apart.

### FIELD OF THE INVENTION

The present invention relates to methods of forming cards, such as business cards, and to the construction of a sheet assembly defining a plurality of blank cards, that may be passed through laser or ink jet printers or copiers.

### BACKGROUND OF THE INVENTION

A sheet of business cards as known in the prior art is shown in FIG. 1 generally at 100. Sheet 100 is a drawing of the sheet after having passed through a laser or ink jet printer and with desired indicia, shown generally at 104, printed thereon. Sheet 100 was formed with a gridwork of horizontal and vertical microperforations 108 and 110 extending the full length and width of the sheet. The microperforations 108 and 110 are typically more than five per inch. Although the microperforations are small and close together, when a plurality of cards 112, after printing indicia thereon, are separated from one another by tearing along the microperforations 108 and 110, clean cuts or edges do not result. Rather, the edges 114 of the cards 112 are slightly fuzzy as shown in the enlarged view of FIG. 2. In one particular embodiment, sheet 100 may be coated on a top and/or bottom surface with a printable coating material, such as a photo-receptive coating or a toner anchorage coating. When the coating material is included, the microperforations 108 and 110 extend completely there through.

Accordingly, there is a need for a sheet assembly and method of fabricating a sheet assembly that eliminates fuzzy edges when a plurality of cards having indicia printed thereon are separated from one another. A card having a clean, knife cut edge is desired for a more professional appearing card.

### BRIEF SUMMARY OF THE INVENTION

A sheet assembly is provided, the assembly including a sheet having a front surface and an opposed second surface separated by a thickness, and defined by a length and width. A coating material is formed on at least the second surface of the sheet and having a thickness. First and second substantial-cut lines are formed extending substantially the thickness of the sheet and extending substantially the length and width of the sheet, without extending substantially the thickness of the coating material. The substantial-cut lines extend between 70-100% through the thickness of the sheet from a front surface towards the back surface of the sheet assembly. The substantial-cut lines do not extend substantially into the coating material formed on the second surface. In an alternative embodiment, the substantial-cut lines may extend somewhat into the coating material. In a preferred embodiment, the sheet is die cut to form the substantial-cut lines. The substantial-cut lines form on the sheet, two columns of business card blanks with paper waste strips at the side (and end) margins and optionally, between the columns. The sheet is then passed through a laser or ink jet printer or copier and the desired indicia printed on each of the blanks. The printed card blanks are separated from one another along the substantial-cut lines. The borders or edges of the card are clean, superior to the prior art microperforated cards.

In addition, a sheet assembly is provided, the assembly including a sheet having a first surface and an opposed second surface separated by a thickness, and defined by a length and width. A coating material is formed on the second surface of the sheet and having a thickness. A plurality of substantial-cut lines are formed extending substantially the thickness of the sheet without extending substantially the thickness of the coating material. The substantial-cut lines together define at least a substantial portion of a perimeter of at least one printable media which can be easily and cleanly separated from the sheet along the substantial-cut line to form individual printed media. The sheet is adapted to be passed through a printer or copier.

In addition, a sheet assembly is provided, the assembly including a single-sheet construction printable sheet having a first surface and an opposed second surface separated by a thickness, and defined by a length and width. The assembly further includes a coating material formed on the second surface of the single-sheet construction printable sheet, and having a thickness. A plurality of separation lines are formed on the sheet and dividing the sheet into a plurality of connected sheet portions. The separation lines comprising substantial-cut lines extending through a substantial portion of a thickness of the sheet and without extending substantially into the coating material and thereby forming a plurality of thin uncut intact sheet portions. The sheet is adapted to be passed through a printer or copier and desired indicia printed on the sheet portions. The thin uncut intact sheet portions collectively comprise the sole means for keeping the sheet portions together while the sheet is passed through the printer or copier to maintain the integrity of the sheet until the sheet portions are subsequently separated along the separation lines to form a plurality of individual printed media.

### BRIEF DESCRIPTION OF THE DRAWINGS

The present invention will hereinafter be described in conjunction with the following drawing figures, wherein like numerals denote like elements, and

FIG. 1 is a front view of a sheet of business cards of the prior art, after having been printed, and showing one of them being torn away along a plurality of microperforation lines;

FIG. 2 is an enlarged view taken on circle 2 of FIG. 1;

FIG. 3 is a perspective view showing a sheet assembly of the present invention passing through a printer;

FIG. 4 is a front elevation view of a sheet assembly of the present invention after a printing operation thereon;

FIG. 5 is a partial cross-sectional view of the sheet assembly of FIG. 4, taken along line 5-5, according to the present invention;

FIG. 6 is a front elevation view of an alternate embodiment of a sheet assembly of the present invention after a printing operation thereon;

FIG. 7 is a partial cross-sectional view of the sheet assembly of FIG. 4, taken along line 5-5, during the separation process according to the present invention;

FIG. 8 is a partial cross-sectional view of a sheet assembly in accordance with an alternate embodiment of the present invention;

FIG. 9 is a partial cross-sectional view of a sheet assembly in accordance with another alternate embodiment of the present invention;

FIG. 10 is a partial cross-sectional view of a sheet assembly in accordance with yet another alternate embodiment of the present invention; and

FIG. 11. is a partial cross-sectional view of a sheet assembly in accordance with another alternate embodiment of the present invention.

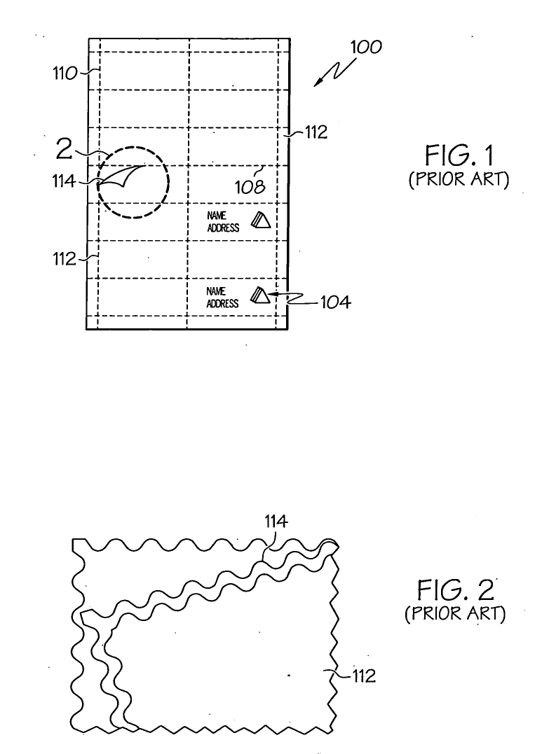

### DETAILED DESCRIPTION OF THE INVENTION

The following detailed description of the invention is merely exemplary in nature and is not intended to limit the invention or the application and uses of the invention. Furthermore, there is no intention to be bound by any theory presented in the preceding background of the invention or the following detailed description of the invention.

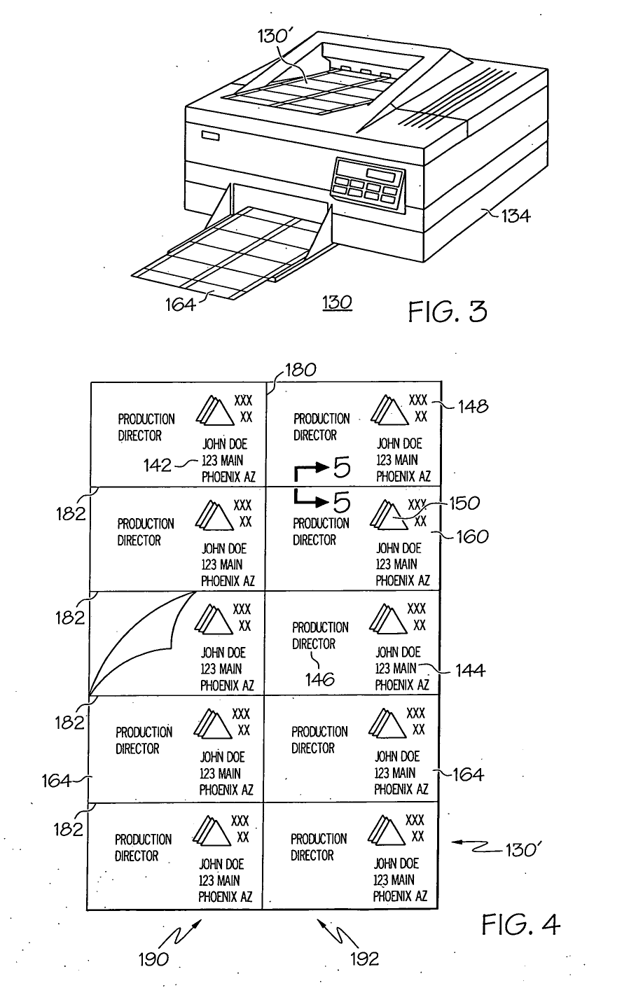

Referring to FIGS. 3-6 a sheet assembly of the present invention is shown generally at 130. The sheet assembly 130 is shown at the bottom left of FIG. 3 before entering a printer 134, and in the state it would be in when purchased by a user (after removal from its packaging (not shown)). The sheet assembly 130′ that is shown in the upper right of FIG. 3 and (in isolation) in FIG. 4 is exemplary of a sheet 130 after it has passed through the printer 134, and with identifying indicia 140 printed thereon. As an example, the indicia 140 can include a name 142, address 144, title 146, company name 148 and company logo 150. It can additionally or alternatively include other information such as telephone and facsimile numbers and/or E-mail addresses, as desired. The printer 134 can be a laser or ink jet printer, or photocopier.

In this particular embodiment, the sheet assembly includes a sheet of paper sheet of feedstock 160, such as ten mil thick cardstock. The thickness of the paper sheet of feedstock 160 is preferably between seven and twenty mils. A pattern of sheet portions or cards 164 are defined on the sheet by a pattern of lines. The sheet portions or cards 164 are preferably rectangular, but could also define various other shapes, such as those with curved edges, non-rectangular polygons, or the like. In addition, greeting card type layouts, CD label layouts, jewel case inserts, and sheets with no surrounding matrix frame are anticipated. In this particular embodiment, the sheet of feedstock 160 is 8½×11 inches and each of the portions 164 has the dimensions of a traditional business card (e.g., 2×3½ inches). However, various other feedstock sheet sizes could also be used including, for example, 8½×14, A4, A3, 11×17, 5×7, 4×6, or the like.

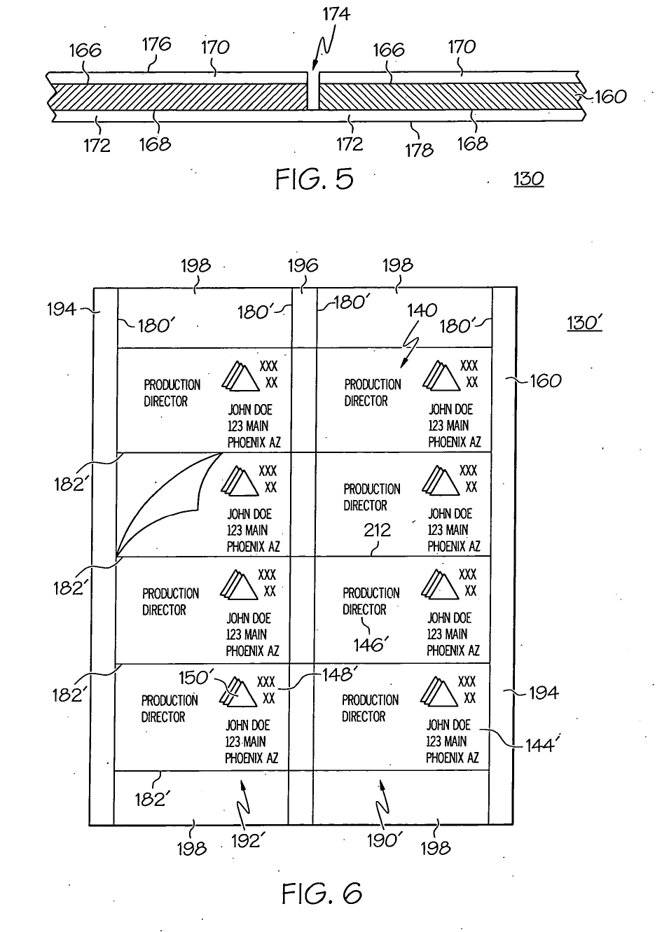

In this particular embodiment, and as best seen in cross-section in FIG. 5, sheet of feedstock 160 has coated on a first surface 166 and second surface 168 thereof a first coating material 170 and a second coating material 172, respectively. It should be understood that while the terms “first” and “second” are used to describe the coating material, that this is not intended as a limitation of the sequence of application of the coating material during the fabrication of sheet assembly 130. First coating material 170 and second coating material 172 are preferably formed so that the sheet assembly 130 is symmetrical. This symmetry provides increased lay-flat qualities, despite environmental factors that may be present, such as humidity or variation in temperature. The first coating material 170 and the second coating material 172 additionally provide for single-sided or double-sided printing in the resulting product. First coating material 170 and second coating material 172 may be formed of any one of numerous suitable coating materials that are optimized for print quality and tensile strength. Suitable materials include an ink receptive material, such as silica or alumina, that is held in place by a binder, such as an ethylene vinyl acetate (EVA) based binder. In this particular embodiment, the first coating material 170 and the second coating material 172 are formed of silica having a thickness in a range of 10-35 microns, with a preferred range of 17-28 microns, and a preferred thickness of 20 microns. The first coating material 170 and the second coating material 172 preferably consist of the same coating material.

The coating of first surface 166 and second surface 168 may be accomplished in a single spray process in which surfaces 166 and 168 are sprayed with the coating material 170 and 172 using a single station sprayer coating apparatus. During this process, the first surface 166 is sprayed, and then sheet of feedstock 160 is flipped over and passes through the coating apparatus a second time to deposit the second coating material 172 on the second surface 168. Alternatively, a coating apparatus including a double sprayer station may be used to achieve deposition of the first and second coating materials 170 and 172 on the first surface 166 and the second surface 168 simultaneously, during one pass through the sprayer station.

Alternative methods may be used to apply coating materials 170 and 172 to surfaces 166 and 168, including, but not limited to slot coating, die coating, meyer rod coating and knife coating. Additionally, alternative methods may include web-based methods including roll to roll and roll to sheet methods.

A preferred method of applying coating materials 170 and 172 to surfaces 166 and 168 includes providing a roll of feedstock 160. The roll of feedstock 160 is unwound and coating material 170 is applied to surface 166 by die coating. The coated web is then transported through a first dryer to dry coating material 170. Upon exiting the dryer, the web may be flipped over and coating material 172 applied to surface 168 by die coating. Alternatively, coating material 172 may be applied to surface 168 by die coating without flipping the web over. After coating material 172 is applied, the web is transported through a second dryer to dry coating material 172. Alternatively, the web may be transported through the first dryer a second time. In yet another alternative, both coating materials 170 and 172 may be applied to respective surfaces 166 and 168 prior to the web being transported through the dryer.

Next, a plurality of defining lines are formed as substantial-cut line(s) 174, of which only one is shown. Substantial-cut line(s) 174 are cut along the length and substantial width of sheet assembly 130, all of the way through the sheet of feedstock 160; that is, the line(s) 174 are cut from a top surface 176 of the first coating material 170, and through sheet of feedstock 160 towards the second coating material 172. In this particular embodiment, substantial-cut line(s) 174 extends completely through sheet of feedstock 160, but does not extend into second coating material 172. In an alternate embodiment, the substantial-cut line(s) 174 extends into the second coating material 172. In yet another embodiment, the substantial-cut line(s) 174 does not extend completely through the sheet of feedstock 160. For example, when a 10-mil thick cardstock is used for the sheet of feedstock 160, the substantial-cut line(s) 174 may extend 9.3 to 9.5 mils through the cardstock. In general, substantial-cut line(s) 174 can extend between seventy and one hundred percent there through. The substantial-cut line(s) 174 can be formed by die cutting, by trimming wheels (rotary knives), laser scoring, or chemical or acid etching.

A preferred pattern of defining substantial-cut line(s) 174 is best shown in FIG. 4. The pattern includes a lengthwise line 180 extending the length of the sheet of feedstock 160 and defining two parallel columns 190 and 192. The pattern further includes spaced parallel widthwise lines 182 extending the width of the sheet of feedstock 160 across the columns 190 and 192. As can be understood from FIG. 4, the lengthwise line 180 and the widthwise lines 182 divide sheet of feedstock 160 into ten substantially equal size cards 164.

The lengthwise line 180 and the widthwise lines 182 are each formed as substantial-cut line(s) 174 as disclosed above. The substantial-cut line(s) 174 define a smooth edge and thus are preferred over microperforated. The cards 164 can also be separated with little effort. The pattern of the substantial-cut line(s) 174 provides the card stock sheet of feedstock 160 with sufficient integrity to reliably pass through the printer 134 or copier without breaking apart.

In an alternate embodiment, a sheet of feedstock 160′ may include a plurality of lengthwise substantial-cut line(s) 174′ as best illustrated in FIG. 6. It should be noted that all components of FIG. 6 that are similar to the components illustrated in FIGS. 3-5, are designated with similar numbers, having a prime added to indicate the different embodiment. More specifically, in this alternative embodiment, substantial-cut lines 174′ define a pattern including four parallel lengthwise lines 180′ extending the length of the sheet of feedstock 160′ and defining two parallel columns 190′ and 192′ with a plurality of waste strips 194 at the outer edges and a center waste strip 196 between the columns 190′ and 192′. The pattern further includes a plurality of spaced parallel widthwise lines 182′ extending the widths of the columns 190′ and 192′, but not beyond them and with a plurality of waste strips 198 at the outer edges. It should be understood that in an alternate embodiment widthwise lines 182′ can extend beyond columns 190′ and 192′ without affecting the integrity of sheet assembly 130′. As can be understood from FIG. 6, the lengthwise lines 180′ define the left and right edges of the sheet portions or cards 164 and the widthwise lines 182′ form the top and bottom edges thereof.

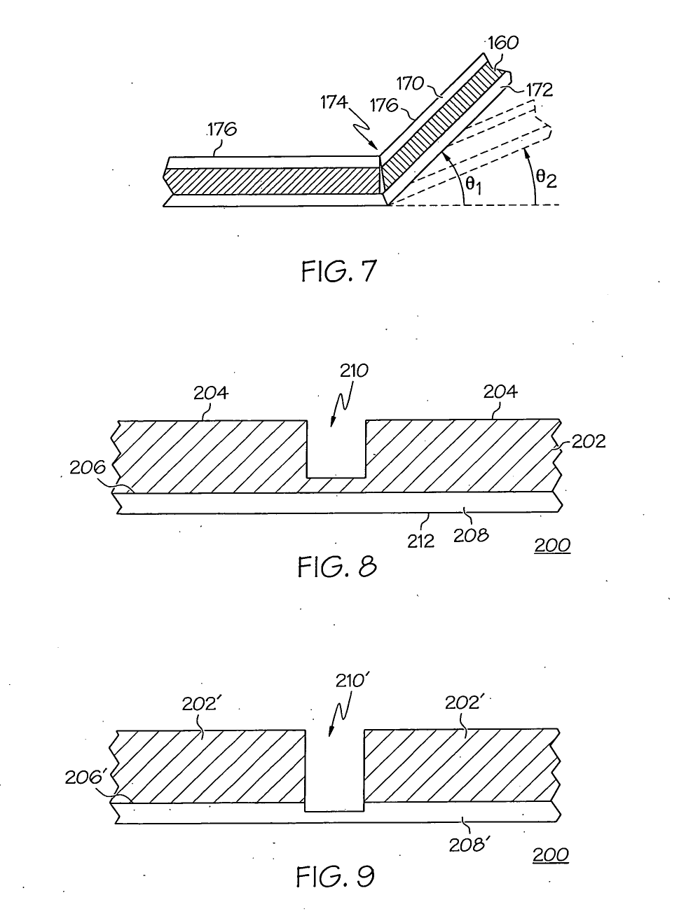

Referring now to FIG. 7, after the sheet assembly 130 has passed through the printer 134 (FIG. 3) and the desired indicia 140 (FIG. 4) has been printed thereon, the individual cards (or printed media) 164 (FIG. 4) are separated by, for example, folding the edges of sheet of feedstock 160 toward surface 176 of first coating material 170 along the substantial-cut line(s) 174. This folding action breaks or fractures the second coating material 172 and provides separation along substantial-cut line(s) 174. The folding of sheet assembly 130 along substantial-cut line(s) 174 will have a fracture angle, referred to as θ. The fracture angle is dependent upon the age of the sheet assembly and its susceptibility to environmental factors, such as humidity and temperature. As illustrated, a fracture angle of θ₁ will occur when the sheet assembly 130 is newly fabricated or where humidity levels may be high. A fracture angle indicated by θ₂, where θ₁ is greater than θ₂, will occur when the sheet assembly 130 is aged, and humidity levels are low.

Referring now to FIG. 8, illustrated is an alternative embodiment of the sheet assembly, generally referenced 200. Sheet assembly 200 is generally the same as sheet assembly 130 of FIGS. 3-5, except in this particular embodiment a single coating material layer is used. More specifically, sheet assembly includes a sheet of feedstock 202 such as the ten mil thick cardstock previously mentioned. A pattern of sheet portions or cards (not shown) are defined on the sheet by a pattern of lines as previously described. In this particular embodiment, the sheet of feedstock 202 is 8½×11 inches and includes portions having dimensions of a traditional business card (e.g., 2×3½ inches).

During fabrication of sheet assembly 200, provided is the sheet of feedstock 202, having a first surface 204, and an opposed second surface 206. A coating material 208 is applied to the second surface 206 by spraying the coating material on the surface. The coating of surface 206 may be accomplished in a single spray process in which surface 206 is sprayed with the coating material using a single station sprayer. In contrast to the embodiment described in FIGS. 3-5, this particular embodiment only includes a coating material on a single surface of the sheet of feedstock 202. Coating material 208 is generally similar to first coating material 170 and second coating material 172 of the previously described embodiment. Alternative means of applying coating material 208 are similar to those for applying coating material 170 (FIG. 3-5).

A plurality of defining lines are formed in sheet assembly 200 subsequent to the coating of sheet of feedstock 202. More specifically, as illustrated in FIG. 8, a plurality of substantial-cut lines 210, of which only one is illustrated, are cut along substantially the entire length and width of the sheet assembly. Substantial-cut line(s) 210 are cut substantially but not all of the way through sheet assembly 200; that is, the sheet assembly 200 is cut from the first surface 204 of the sheet of feedstock 202 towards the second surface 206 of the sheet of feedstock 202, but in contrast to the first embodiment, not completely through the sheet of feedstock 202. A preferred embodiment has the substantial-cut line(s) 210 extending between seventy and ninety-eight percent there through the sheet of feedstock 202.

Alternatively, and as best illustrated in FIG. 9, a sheet assembly 200′ including a sheet of feedstock 202′, generally similar to feedstock 202 of FIG. 8, is provided. It should be noted that all components of FIG. 9 that are similar to the components illustrated in FIG. 8, are designated with similar numbers, having a prime added to indicate the different embodiment. Sheet assembly 200′ includes a plurality of substantial-cut line(s) 210′, only one of which is illustrated, formed completely through the sheet of feedstock 202′, and extending into a coating material 208′ formed on a second surface 206′ of sheet of feedstock 202′. In this alternative embodiment, while the substantial cut line(s) 210′ extends into the coating material 208′, it does not extend completely through the coating material 208′ thus maintaining the integrity of sheet assembly 200′. Similar to the previously described substantial-cut lines, the substantial-cut line(s) 210′ in this embodiment may be formed by any suitable means, such as by die cutting, trimming wheels (rotary knives), laser scoring, chemical or acid etching.

Referring again to FIG. 8, the preferred pattern of defining lines is formed similar to those described with respect to the first disclosed embodiment. The substantial-cut line(s) 210 define a smooth edge. They can also be separated with little effort. In that the substantial-cut line(s) 210 do not extend, or only partially extend, into the coating material 208, the sheet of feedstock 202 is not likely to be torn along the substantial-cut line(s) 210. The pattern of substantial-cut line(s) 210 still provides the sheet assembly 200 with sufficient integrity to reliably pass through a printer or copier without breaking apart. A second defining line may be formed on a surface 212 of coating material 208 that corresponds to the substantial-cut line(s) 210 formed through the sheet of feedstock 202.

After the sheet assembly 200 has passed through the printer and the desired indicia has been printed thereon, the individual cards (or printed media) are separated by folding toward first surface 204 along the substantial-cut line(s) 210. This folding action breaks or fractures the coating material 208 and provides separation along substantial-cut line(s) 210. In the instance where a second defining line is formed partially through coating material 210 on surface 212, the sheet may be folded towards surface 212, instead of surface 204 to separate the cards. Similar to the first disclosed embodiment, the folding of sheet assembly 200 along substantial-cut line(s) 210 will include similar multiple fracture angles and susceptibility to environmental factors.

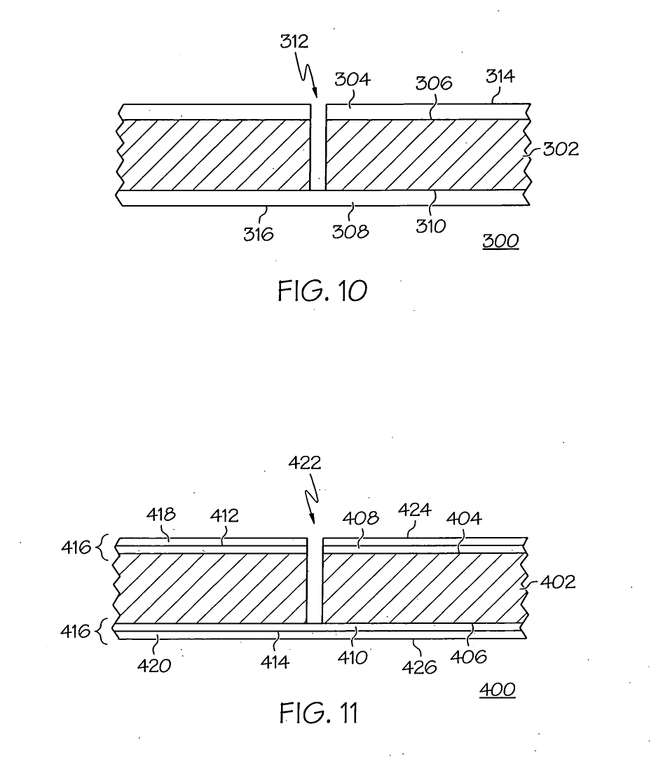

Referring now to FIG. 10, illustrated is yet another alternative embodiment of the sheet assembly of the present invention, generally referenced 300. Sheet assembly 300 is generally the same as sheet assembly 130 of FIGS. 3-5, except in this particular embodiment a polymer film layer is used instead of a sheet of paper. More specifically, the sheet assembly 300 includes a polymer film layer 302 preferably formed of a thermal plastic resin, polyester, polypropylene, polyolefin, polystyrene, or the like and having a thickness of approximately 10 microns. Polymer film layer 302 may be opaque or transparent depending on the desired product outcome. A pattern of sheet portions or cards (not shown) are defined on the sheet assembly 300 by a pattern of lines as previously described. In this particular embodiment, the sheet assembly 300 is 8½×11 inches and includes portions having dimensions of a traditional business card (e.g., 2×3½ inches).

During fabrication of sheet assembly 300, a first coating material 304 is applied to a first surface 306 of polymer film 302 and a second coating material 308 is applied to a second surface 310 of polymer film layer 302 by spraying the coating material on the surfaces. The coating of surfaces 306 and 310 may be accomplished in a spray process in which surfaces 306 and 310 are sprayed with the coating material similar to the processes described in FIGS. 3-6. It should be understood that while a first coating material 304 and a second coating material 308 are described, anticipated is the use of a single coating material on a single surface of polymer film layer 302 similar to the embodiments previously described in FIGS. 8 and 9. First coating material 304 and second coating material 308 are generally similar to first coating material 170 and second coating material 172 of the previously described embodiment.

A plurality of defining lines are formed in sheet assembly 300 subsequent to the coating of polymer film layer 302. More specifically, as illustrated in FIG. 10, a plurality of substantial-cut lines 312, only one of which is illustrated, are cut along the length and width of sheet assembly 300. Substantial-cut line(s) 312 are cut substantially but not all of the way through sheet assembly 300; that is, the sheet assembly 300 is cut from a first surface 314 of the sheet assembly 300 towards a second surface 316 of the sheet assembly 300. A preferred embodiment has the substantial-cut line(s) 312 extending completely there through the polymer film layer 302, but would not extend into the second coating material 308. Alternatively, substantial cut line(s) 312 would extend only partially through polymer film layer 302, or through polymer film layer 302 and partially into the second coating material 308, as described with the previous embodiments. The substantial-cut line(s) 312 can be formed by die cutting, by trimming wheels (rotary knives), laser scoring, or chemical or acid etching.

The preferred pattern of defining lines is formed similar to those described with respect to the first disclosed embodiment. The substantial-cut line(s) 312 define a smooth edge. They can also be separated with little effort. In that the substantial-cut line(s) 312 do not extend, or only partially extend, into the second coating material 308, the sheet assembly 300 is not likely to be torn along the substantial-cut line(s) 312. The pattern of substantial-cut line(s) 312 provides the sheet of polymer film 302 with sufficient integrity to reliably pass through a printer or copier without breaking apart. In an alternative embodiment, a second defining line may be formed on the surface 316 of second coating material 308 that corresponds to the substantial-cut line(s) 312 formed through the polymer film 312.

After the sheet assembly 300 has passed through the printer and the desired indicia have been printed thereon, the individual cards (or printed media) are separated by folding along the substantial-cut line(s) 312 similar to the previously described embodiments.

In the described embodiments, the sheet assembly may further include an ink receptive coating layer formed on outermost surface of at least one of layers of the coating material. Referring now to FIG. 11, illustrated is a sheet assembly 400, formed generally similar to sheet assembly 130 of FIGS. 3-5. The sheet assembly 400 includes a sheet of feedstock 402 such as a ten mil thick cardstock. A pattern of sheet portions or cards (not shown) are defined on the sheet assembly 400 by a pattern of lines. Sheet of feedstock 402 has coated on a first surface 404 and second surface 406 thereof a first coating material 408 and a second coating material 410, respectively. First coating material 408 and second coating material 410 are formed so that sheet assembly 400 is symmetrical. The first coating material 408 and the second coating material 410 in this particular embodiment are formed of an ink receptive material and a binder material such as that described with regard to the first embodiment, yet in this particular embodiment, first coating material 408 and second coating material 410 typically include a higher percentage of binder material for tensile strength. The first coating material 408 and the second coating material 410 have formed on their outermost surfaces 412 and 414, respectively, an ink receptive coating layer, thereby forming a multi-layer coating 416 on sheet of feedstock 402. More particularly, formed on the outermost surface 412 of first coating material 408 is an ink receptive coating layer 418. Similarly, formed on the outermost surface 414 of the second coating material 410 is an ink receptive coating layer 420. The ink receptive coating layers 418 and 420 are formed as specialty top coatings which trap ink droplets during the printing of sheet assembly 400. First coating material 408 and second coating material 410 serve to draw the liquid out of the printing ink thereby allowing the pigment in the ink to sit on a surface of ink receptive coating layer 418, when single side printing is employed, and additionally on ink receptive coating layer 420 when double side printing is employed. Ink receptive coating layers 418 and 420 are preferably formed of a material that is highly receptive to the printing with ink thereon, such as that described with respect to the coating material layers of the first embodiment, wherein a higher percentage of pigment material, such as silica, is used.

A plurality of defining lines are formed in sheet assembly 400 subsequent to the fabrication of the multi-layer coating 416. More specifically, as illustrated in FIG. 11, a plurality of substantial-cut line(s) 422, only one of which is illustrated, are cut along its length and width. The substantial-cut line(s) 422 are cut substantially, but not all of the way, through sheet assembly 400; that is, sheet assembly 400 is cut from a first surface 424 of the sheet assembly 400 towards a second surface 426 of the sheet assembly 400. A preferred embodiment has the substantial-cut line(s) 422 extending completely through the sheet of feedstock 402, but would not extend into the second coating material 410 or the ink receptive coating layer 420. The substantial-cut line(s) 422 can be formed by die cutting, by trimming wheels (rotary knives), laser scoring, or chemical or acid etching.

The preferred pattern of defining lines is formed similar to those described with respect to the previously disclosed embodiment. The substantial-cutline(s) 422 define a smooth edge. They can also be separated with little effort. In that the substantial-cut line(s) 422 do not extend into the second coating material 410 or the ink receptive coating layer 420, the sheet assembly 400 is not likely to be torn along the substantial-cut line(s) 422. The pattern of substantial-cut line(s) 422 still provides the sheet of feedstock 402 with sufficient integrity to reliably pass through a printer or copier without breaking apart. Alternatively, the defining lines may extend at least partially into the second coating material 410, or a second defining line may be formed on the surface 426 of ink receptive coating 420 that corresponds to the substantial-cut line(s) 422 formed through the sheet of feedstock 402.

After the sheet assembly 400 has passed through the printer and the desired indicia have been printed thereon, the individual cards (or printed media) are separated by folding along the substantial-cut line(s) 422 similar to the previously described embodiments.

From the foregoing detailed description, it will be evident that there are a number of changes, adaptations, combinations, and modifications of the present invention which come within the province of those skilled in the art. For example, instead of paper the sheets can be laminated sheets, such as plastic and card stock, instead of rectangular, the cards (or printed or printable media) can be triangular, circular or any other usable shape and the sheet assembly may include any combination of coating material layers and ink receptive coatings as disclosed. Coating materials and ink receptive coatings may also be applied by other means as known in the art. However, it is intended that all such variations not departing from the spirit of the invention be considered as within the scope thereof as limited solely by the claims appended hereto.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention. It being understood that various changes may be made in the function and arrangement of elements described in an exemplary embodiment without departing from the scope of the invention as set forth in the appended claims.

What is claimed is:

1. A sheet assembly for passing through a printer or copier and separating out into individual printed cards, comprising:
a sheet having a first surface and an opposed second surface separated by a thickness and defined by a length and width;
a coating material formed on the second surface of the sheet and having a thickness;
first and second substantial-cut lines extending substantially the thickness of the sheet and extending substantially the length and width of the sheet, without extending substantially the thickness of the coating material;
wherein the substantial-cut lines define a column or row of card blanks that are separable from one another along the substantial-cut lines; and
wherein the sheet is adapted to be passed through a printer or copier.

2. The assembly of claim 1, wherein the sheet is a sheet of paper.

3. The assembly of claim 2, wherein the sheet is 10 Mil thick cardstock.

4. The assembly of claim 1, wherein the sheet is a sheet of a polymer film.

5. The assembly of claim 1, wherein the coating material is formed of a material optimized for print quality and tensile strength.

6. The assembly of claim 5, wherein the coating material has a thickness in a range of 10-35 microns.

7. The assembly of claim 1, further including a second coating material formed on the first surface of the sheet.

8. The assembly of claim 7, further including an ink receptive coating formed on an outermost surface of the second coating material.

9. The assembly of claim 1, wherein the first and second substantial-cut lines extend between 70 and 100 percent of the thickness of the sheet, and without extending into the second coating material.

10. A sheet assembly for passing through a printer or copier and then separating out into at least one printed media, comprising:
a sheet having a first surface and an opposed second surface separated by a thickness and defined by a length and width;
a coating material formed on the second surface of the sheet and having a thickness;
a plurality of substantial-cut lines extending substantially the thickness of the sheet without extending substantially the thickness of the coating material; and
wherein the substantial-cut lines together define at least a substantial portion of a perimeter of at least one printable media which can be easily and cleanly separated from the sheet along the substantial-cut line to form individual printed media; and
wherein the sheet is adapted to be passed through a printer or copier.

11. The assembly of claim 10, wherein the sheet is a sheet of paper.

12. The assembly of claim 10, wherein the sheet is 10 Mil thick cardstock.

13. The assembly of claim 10, wherein the sheet is a sheet of a polymer film.

14. The assembly of claim 10, wherein the coating material is formed of a material optimized for print quality and tensile strength and having a thickness in a range of 10-35 microns.

15. The assembly of claim 10, wherein the individual printed media comprise a printed rectangular business card.

16. The assembly of claim 10, further including a first coating material formed on the first surface of the sheet and a second coating material formed on the second surface of the sheet.

17. The assembly of claim 16, wherein the substantial-cut lines extend from an outermost surface of the first coating material to between 70 and 100 percent of the thickness of the sheet.

18. The assembly of claim 17, wherein the substantial-cut lines extend from an outermost surface of the first coating material through the sheet, and extend partially into the second coating material without penetrating through the second coating material.

19. The assembly of claim 16, further including an ink receptive coating formed on an outermost surface of the first coating material.

20. A sheet assembly comprising:
a single-sheet construction printable sheet having a first surface and an opposed second surface separated by a thickness, and defined by a length and width;
a coating material formed on the second surface of the single-sheet construction printable sheet, and having a thickness;
a plurality of separation lines formed on the sheet and dividing the sheet into a plurality of connected sheet portions; and
the separation lines comprising substantial-cut lines extending through a substantial portion of a thickness of the sheet and without extending substantially into the coating material and thereby forming the plurality of connected sheet portions;
wherein the sheet is adapted to be passed through a printer or copier and desired indicia printed on the sheet portions; and
wherein the coating material comprises a means for keeping the plurality of connected sheet portions together while the sheet is passed through the printer or copier to maintain the integrity of the sheet until the plurality of connected sheet portions are subsequently separated along the separation lines to form a plurality of individual printed media.

21. The sheet assembly of claim 20, wherein the substantial-cut lines extend between approximately 70 and 100 percent of the thickness of the sheet.

22. The sheet assembly of claim 20, wherein the individual printed media comprise printed rectangular business cards.

23. The sheet assembly of claim 20, wherein the substantial-cut lines include first and second substantial-cut lines extending substantially the length and width of the sheet.

24. The sheet assembly of claim 20, wherein the sheet comprises 10 mil thick cardstock.

25. The sheet assembly of claim 20, wherein the sheet comprises an approximately 10 mil thick polymer film.

26. The sheet assembly of claim 20, wherein the coating material forms an intact uncut portion on the second surface of the sheet.
